(19) United States
(12) Patent Application Publication
(10) Pub. No.: US 2012/0036926 A1
(43) Pub. Date: Feb. 16, 2012

(54) DEVICE AND METHOD FOR CONTINUOUSLY MEASURING THE FLOW VELOCITY AND TOTAL VOLUME OF A FLUID, IN PARTICULAR OF URINE

(75) Inventors: Marcus Veeck, Koblenz (DE); Rossana Reho, Munchen (DE); Stephan Joeken, Schopfheim (DE)

(73) Assignee: PULSION MEDICAL SYSTEMS AG, Munich (DE)

(21) Appl. No.: 13/148,335

(22) PCT Filed: Feb. 9, 2009
(86) PCT No.: PCT/EP2009/051437

§ 371 Date: Oct. 14, 2011

(51) Int. Cl. G01F 1/00

(52) U.S. Cl. 73/272 R

(57) ABSTRACT

A device for the continuous measurement of the flow rate of a liquid, in particular the urine of a living being, comprising at least two receiving containers (2, 3) for receiving the liquid, a tubular or hose-like connection part (4) at the lower end of the first receiving container (2), which connection part connects the first receiving container (2) to the second receiving container (3), a first seal (6a/6b) between the first receiving container (2) and the second receiving container (3) at the tubular or hose-like connection part (4), a second seal (7) at the lower end of the second receiving container (3), and a rising pipe (8) which is connected to the second receiving container (3), wherein a measuring device (10) arranged in the region of the upper end of the rising pipe (8).

The invention relates to a device for the continuous measurement of the flow rate of a liquid. The invention further relates to a method for the measurement of the flow rate of a liquid. In particular, the invention relates to a device and a method for the measurement of the flow rate and total volume of the urine of a living being.

Various embodiments of devices for measuring the flow rate and total volume of urine are already known from the prior art. Urinal catheters are predominantly used as Foley catheters in order to carry off urine externally from the urinary bladder via the urethra or via the abdominal wall.

For example, utility model DE 7 808 850 U1 describes a device for measuring and collecting urine. The urine liquid first passes through an opening in the device into a measuring vessel provided with a scale. The measuring vessel is connected to a collection vessel by means of a duct. If the liquid inflow exceeds the capacity of the measuring vessel, the duct attached to the overflow of the measuring vessel carries off the excess urine liquid into the collection vessel. The total volume of the urine can primarily only be determined when the urine volume is low, since the measuring vessel is only dimensioned for small amounts. Owing to the small capacity of the measuring vessel, the device can only be used expediently in the case of reduced urine production, for example in the case of kidney disease. Since DE 7 808 850 U1 merely determines the liquid volume, it is not possible to measure the flow rate of the urine with this device.

Patent specification DE 32 40 191 C2 further refers to a device for measuring urine volume. In order to measure the volume of the urine liquid an ultrasonic measurement is carried out by means of a measuring and control unit. With known dimensions of a container which is provided to receive urine and is located in a supporting arrangement, the volume of the liquid collected over time can be determined by measuring the interval between transmission and return of an echo signal. A tube connected to the receptacle is used to empty said receptacle, wherein the emptying process is carried out manually. The device of DE 32 40 191 C2 has a complicated structure of the supporting arrangement and of the measuring arrangement. The components required for the ultrasonic measurement are associated with high production costs and a high manufacturing and maintenance outlay.

Offenlegungsschrift DE 3 118 158 A1 describes an electronic control and monitoring device for measuring the flow rate and total volume of the urine produced by a patient. The urine liquid passes via a catheter into a chamber of calibrated volume. A valve device is in each case arranged above and below the chamber. An optical sensor device is further provided above the chamber, below the upper valve device. If the lower valve device is closed, the chamber is filled up to the point at which the urine level reaches the optical sensor. The urine is carried off into a collection container by the closed upper valve and the open lower valve. At the same time, with actuation of the valve devices a signal is sent to a monitor in order to record the volume provided in the receiving container and in order to initiate operation of the device which registers flow rate. A drawback of the device of DE 3 118 158 A1 is that the liquid which accumulates when the upper valve device is closed or else faulty causes a backflow of the urine liquid toward the patient since an overflow is not provided. Furthermore, it is not possible with the device to continuously determine the course over time of the measurement of the flow rate of the urine liquid, since the measurement is only initiated once a defined urine level has been reached.

Patent specification DD 149 462 further describes a urine flowmeter for measuring instantaneous values of the urine flow during urination. The urine liquid flows into an open vessel. The vessel is connected to a rising pipe, wherein the air in the rising pipe is displaced as the urine level rises. A nozzle-like narrowing and a heated thermistor, of which the resistance changes as a result of the change in temperature, are arranged at the upper end of the rising pipe in order to deduce the urine flow with the aid of the change in resistance. A drawback of DD 149 462 is that, when the capacity of the vessel is exceeded, the vessel overflows and the thermistor and therefore the entire measuring device could be damaged owing to the urine emerging from the rising pipe. Any urine accumulating when the vessel is emptied cannot be included for a measurement of instantaneous values of the urine liquid. It is also not possible to connect a catheter to the open vessel.

The object of the invention is to provide a device and a method for the continuous measurement of the flow rate of a liquid, in particular the urine of a living being, which can further be used during the emptying process, dispenses with a complicated structure of the supporting arrangement and measuring arrangement, can be applied and used in a simple and time-saving manner for relatively large amounts of urine, and can be combined without difficulty with a measurement of the urine volume.

The object is solved by the device according to claim 1 and 13. The object is further solved by the method according to claim 14. Further embodiments are disclosed in the dependent claims.

The invention therefore relates to a device for the continuous measurement of the flow rate of a liquid, in particular the urine of a living being, comprising at least two receiving containers for receiving the liquid, a tubular or hose-like connection part at the lower end of the first receiving container, which connection part connects the first receiving container to the second receiving container, a first seal between the first receiving container and the second receiving container at the tubular or hose-like connection part, a second seal at the lower end of the second receiving container, and a rising pipe which is connected to the second receiving container, wherein a measuring device is arranged in the region of the upper end of the rising pipe. Owing to the continuous measurement of the flow rate of a liquid, it is possible to measure the course over time of the flow rate at any moment at which the liquid is introduced into the second receiving pouch.

In accordance with an advantageous development of the device the measuring device comprises an anemometric measuring unit. The anemometric measuring unit detects the airflow emerging from the rising pipe. The emerging airflow results from the rise in liquid in the rising pipe owing to the rise in liquid in the second receiving container when the first seal of the device is open and the second seal of the device is closed.

In a further advantageous development of the device the tubular or hose-like connection part is a flexible connection part. The flexible property of the tubular or hose-like connection part makes it possible to squash and squeeze the connection part. The urine flow from the first receiving container to the second receiving container can be stopped by squeezing the flexible connection part at the lower end of the first receiving container.

In a particularly preferred embodiment of the device the device comprises an electronic unit which can be connected to the device in order to analyse the measured values from the measuring device. For example, the measuring device can be connected to the unit by means of a direct cable connection or via a cable-free connection.

The unit is preferably set up in such a way that the first and second seals can be controlled. The unit is preferably an electronic unit.

The first and second seals can preferably be controlled hydraulically, pneumatically or electronically by the electronic unit. The unit can be connected to the first seal and to the second seal of the device, for example by means of a direct cable connection or via a cable-free connection.

An electronic unit in which the first seal, upon activation thereof, seals the tubular or hose-like connection part is particularly preferred. The seal is preferably formed in a radial manner. As already mentioned above, the urine flow from the first receiving container to the second receiving container can be stopped by a radial seal.

The first seal is particularly preferably a valve, in particular a lamellar valve, a rosette valve or an inflatable member. For example, a rosette valve is known from document DE 196 460 60 A1. Other valves or seals are also conceivable.

In a further advantageous development of the device a receiving container is connectable at the lower end of the device via a connection point. In order to carry off the urine liquid from the device, the device is connected to a third receiving container via a connection point.

In a further advantageous development of the device the first receiving container comprises an overflow. If the first receiving container can no longer receive a relatively large amount of liquid when the first seal is closed, it is thus possible to carry off the excess urine via the overflow. The excess liquid is received by the third receiving pouch. If the function of the first or second seal and/or the electronic unit should fail, the excess urine liquid is likewise carried off via the overflow.

In a particularly preferred embodiment of the device the rising pipe is arranged inside the first and second receiving container and inside the tubular or hose-like connection part. The rising pipe is preferably arranged centrally in the device. The flexible tubular or hose-like connection part surrounds the rising pipe and is squeezed when necessary by means of a seal, for example a lamellar valve, in such a way that the flexible connection part is pressed in an annular manner against and around the rising pipe. As already mentioned before, the urine flow inside the device from the first to the second receiving container is stopped as a result of this squeezing process. The rising pipe, which is rigid compared to the flexible connection part, remains spared from the squeezing process, such that the function of the rising pipe in the device is not impaired.

In contrast to the device in which the rising pipe is arranged internally and optionally centrally, the device in a further particularly preferred embodiment comprises a rising pipe which is arranged outside the receiving container and outside the tubular or hose-like connection part. For example the rising pipe is attached to the external surface of the first and second receiving containers by means of a fastening. A lamellar valve as a first seal is not imperatively necessary for such a device, but is quite possible. In this case the lamellar valve would be completely sealed when closed.

In accordance with a further aspect of the invention a device for the continuous measurement of the flow rate of a liquid, in particular urine of a living being, comprises at least one receiving container for receiving liquid, wherein a catheter is connected to the device at a coupling piece of the device, and an anemometric measuring unit which ascertains the speed of the airflow emerging from the device. The urine introduced into the device displaces the air located in the receiving container. The device is sealed from the outside in an airtight manner, in such a way that the air can only escape from the device at the measuring device via the anemometric measuring unit. A connection point to an electronic unit in order to determine the flow rate and the liquid volume is further provided. The volume of a specific amount of liquid introduced into the receiving container advantageously corresponds exactly to the displaced volume of air, i.e. 1 ml urine displaces precisely 1 ml air. The displaced volume of air does not therefore have to be weighted by a factor which adapts the different radii of a rising pipe and a receiving container to one another in order to determine the flow rate of the liquid.

The invention further relates to a method for the continuous measurement of the flow rate of a liquid, in particular the urine of a living being, in which the liquid is fed from a first receiving container into a second receiving container. On its journey from the first to the second chamber, the liquid passes a first seal which is open. The air in a rising pipe, which is connected to the second receiving container, is displaced by the liquid introduced: as the urine is steadily introduced into the second receiving container, the level of the liquid in the second receiving container, and thus the level in the rising pipe rises, in such a way that the liquid in the rising pipe displaces the air; an airflow results from the displaced air. The flow rate of the liquid is determined from the airflow by means of an anemometric measuring unit which is arranged in the measuring device. Once the flow rate has been determined the first seal is closed in such a way that no further liquid can flow off from the first receiving container into the second receiving container. The liquid collected in the second receiving container is then released when the second seal, which is located at the lower end of the second receiving container, is opened. Once this cycle has finished, the second seal is closed and the first seal is opened so the flow rate can be determined afresh.

In an advantageous development of the method the first and second seals are controlled by an electronic unit. The opening and closing function of the first and second seals is triggered by means of an electronic unit. Furthermore, the values of the flow rate which have been recorded by the anemometric measuring unit are processed, recorded and stored by the electronic unit. The unit is connected to the measuring device in order to analyse the measurement results. Similarly to the measuring device itself, the first and second seals are connected to the unit.

In a further advantageous development of the method the volume of the introduced liquid is determined via the value of the flow rate by means of integral formation. By means of an integration method the unit calculates the corresponding liquid volume from the flow rate of the urine liquid. The result of the measurement is then displayed on and stored in the electronic unit.

In a further particularly advantageous development of the method the instantaneous fill level in the second receiving container is determined as a result of the determination of the liquid volume by means of integral formation, in such a way that when a defined fill level in the second receiving container has been reached the necessary opening and closing function of the first and second seals is triggered. In order to determine the instantaneous fill level, the maximum possible receiving volume of the second receiving receptacle is known from the device.

The invention will now be explained in greater detail in an exemplary manner and with reference to drawings. A plurality of preferred embodiments will be described, although the invention is not limited thereto.

In principle, any variant of the invention which is described or suggested within the scope of the present invention may be particularly advantageous depending on the economic and technical conditions in the individual case. Unless otherwise stated and insofar as technically feasible in principle, individual features of the embodiments described can be interchanged or combined with one another and with features known per se from the prior art.

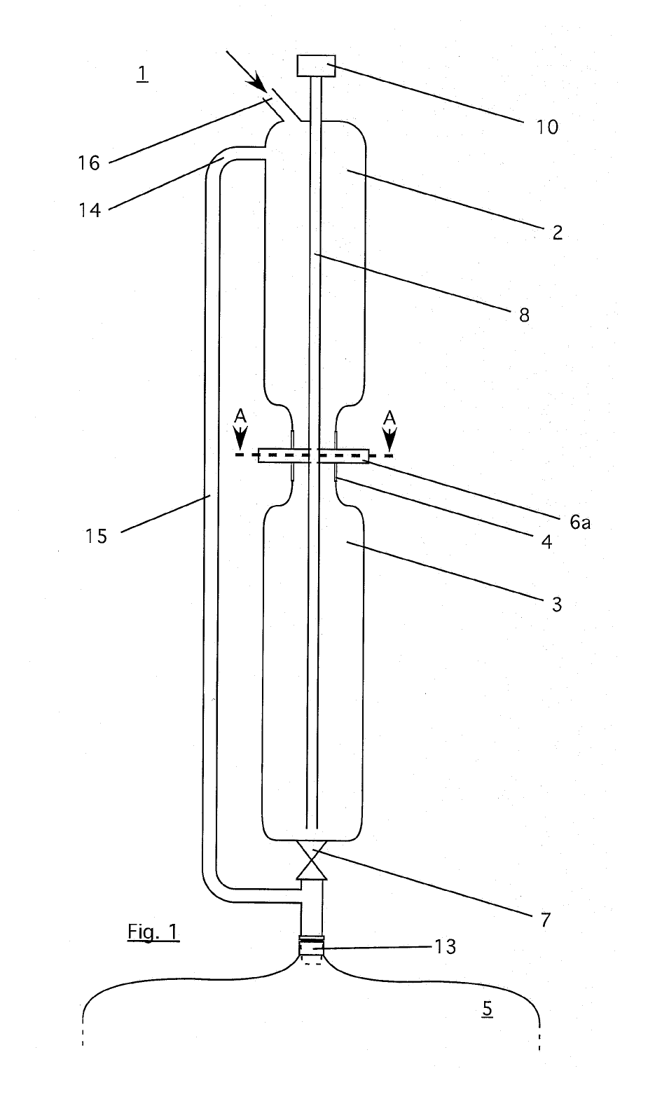

FIG. 1 is a schematic view of a longitudinal section through a device according to the invention for the continuous measurement of the flow rate of urine;

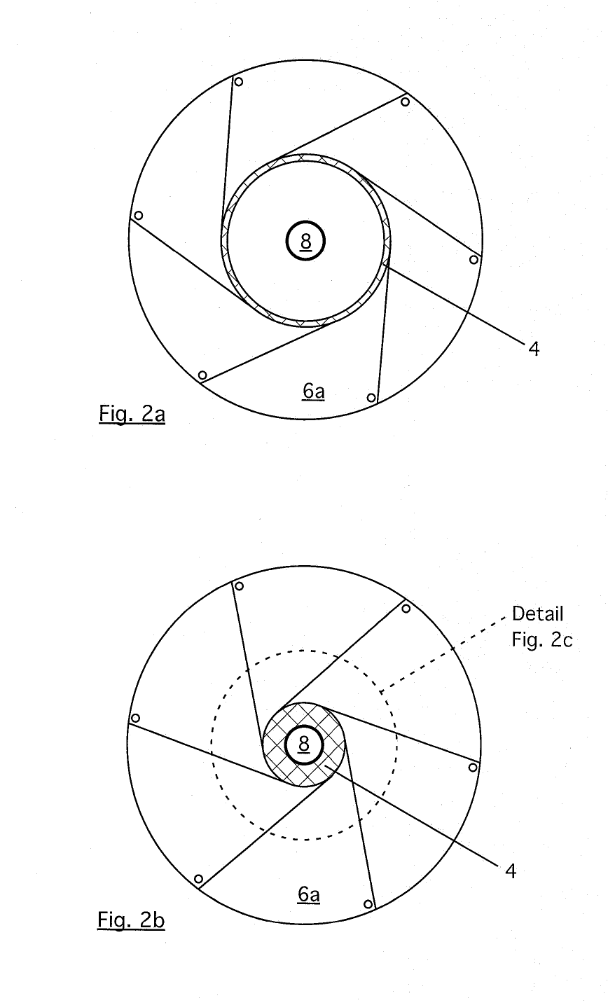

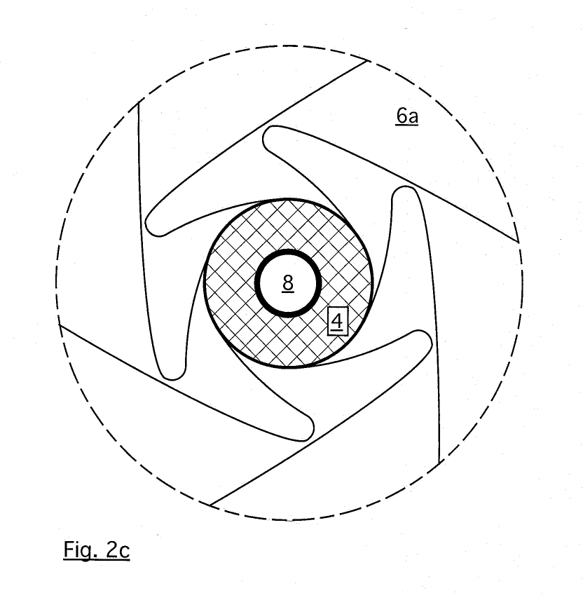

FIG. 2a is a schematic view of a cross-section A-A of a lamellar valve, in the open state, of the device according to the invention from FIG. 1;

FIG. 2b is a schematic view of a cross-section A-A of a lamellar valve, in the closed state, of the device according to the invention from FIG. 1;

FIG. 2c is a schematic view of a detail of the lamellar valve from FIG. 2b;

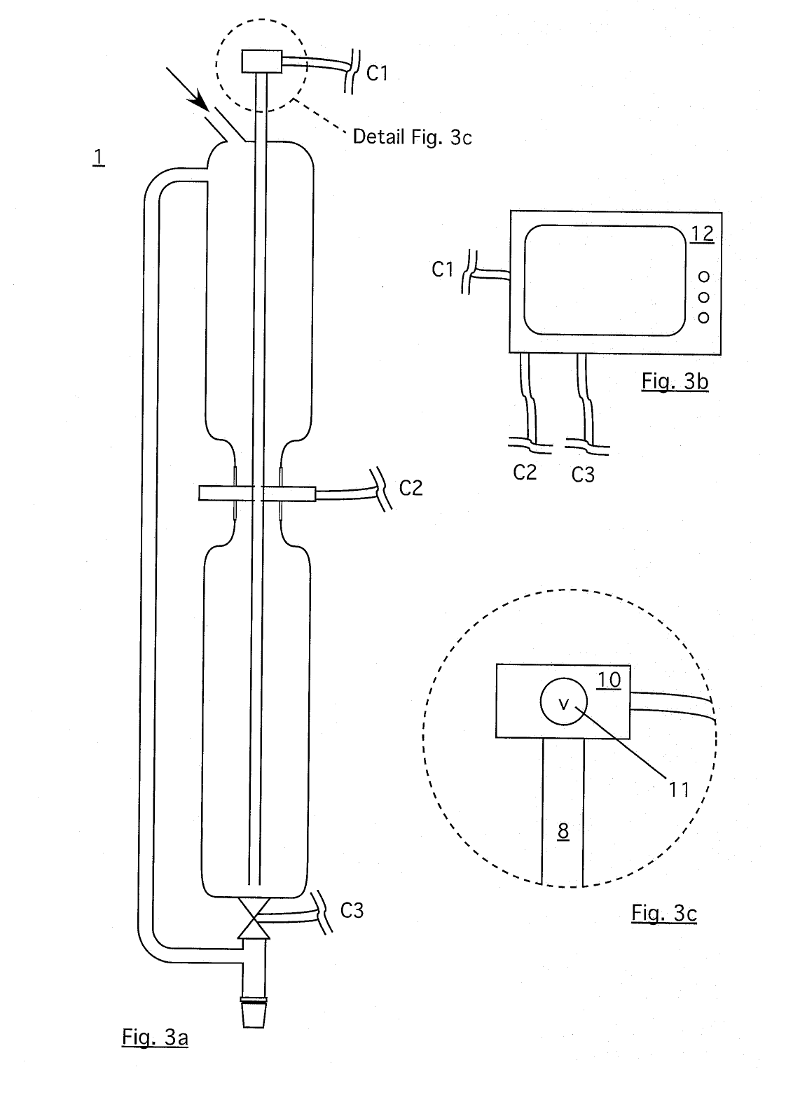

FIG. 3a is a schematic view of a longitudinal section of the device according to the invention from FIG. 1;

FIG. 3b is a schematic view of a connectable unit of the device according to the invention from FIG. 3a;

FIG. 3c is a schematic view of a detail of a measuring device from FIG. 3a;

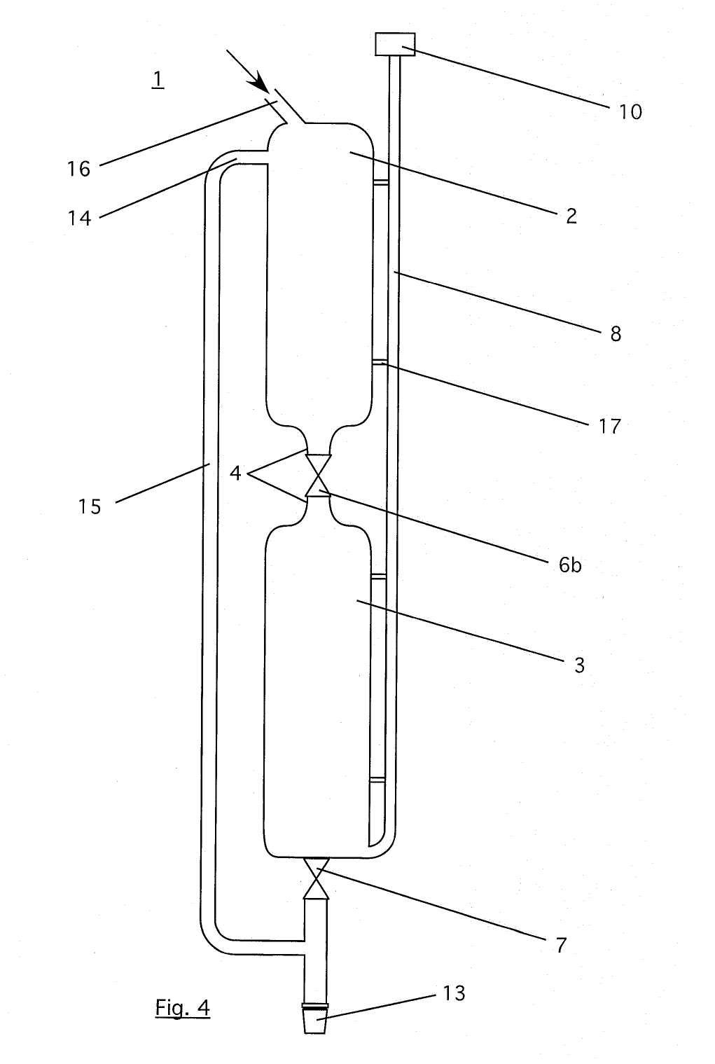

FIG. 4 is a schematic view of a longitudinal section through an alternative device according to the invention for the continuous measurement of the flow rate of urine; and

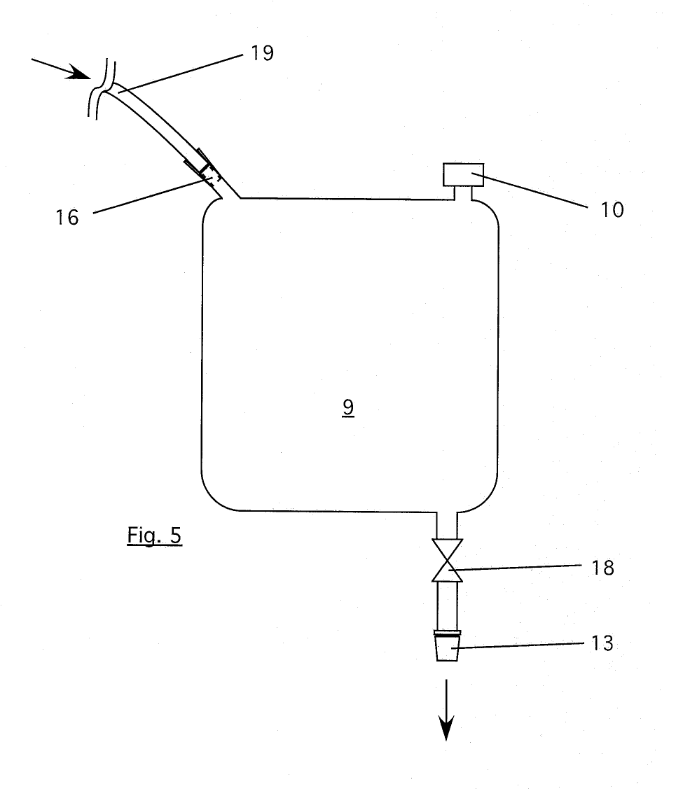

FIG. 5 is a schematic view of a longitudinal section through a further alternative device according to the invention for the continuous measurement of the flow rate of urine.

FIG. 1 is a schematic view of a longitudinal section through a device according to the invention for the continuous measurement of the flow rate of urine. The device 1 comprises two receiving containers 2, 3 for receiving urine liquid. A tubular or hose-like connection part 4 at the lower end of the first receiving container 2 connects the first receiving container 2 to the second receiving container 3. A first seal 6a is attached to the tubular or hose-like connection part 4 between the first receiving container 2 and the second receiving container 3. A second seal 7 is arranged at the lower end of the second receiving container 3. The device further comprises a rising pipe 8 which is connected to the second receiving container 3. A measuring device 10 is arranged in the region of the upper end of the rising pipe 8. The rising pipe 8 is arranged inside the receiving containers 2 and 3 and inside the tubular or hose-like connection part 4.

The urine secreted by a patient via a catheter device first passes via the coupling piece 16 of the device 1 into the first receiving container 2. When the seal 6a is open (FIG. 2a) the urine passes through the first receiving container 2 and is forwarded into the second receiving container 3. The liquid remains in the second receiving container 3 until the second seal 7 is opened.

The rising pipe 8 is arranged in the second receiving container 3 in such a way that a sufficient distance, which makes it possible for the urine to rise in the rising pipe 8, is provided in the region between the lower edge of the rising pipe 8 and the upper edge of the base of the second receiving container 3. When the urine is introduced into the second receiving container 3, the level of liquid in the second receiving container 3 rises. The level in the rising pipe 8 rises in parallel. The liquid in the rising pipe 8 displaces the air in the rising pipe 8. The more liquid arranged in the second receiving container 3, the more air is therefore displaced. An airflow results from the displaced air. The flow rate of the liquid is determined from the resultant airflow by means of an anemometric measuring unit 11 which is arranged in the measuring device 10 (FIGS. 3a-3c).

The first receiving container 2 of the device 1 is closed by means of the seal 6a once a defined fill level has been reached in the second receiving container 3 (FIGS. 2b and 2c), in such a way that no more liquid can flow off from the first receiving container 2 into the second receiving container 3. The second seal 7 at the lower end of the second receiving container 3 is then opened, such that the liquid can flow off via the connection 13 into a third receiving vessel 5.

If, when the first seal 6a is closed, an amount of liquid exceeding the volume of the first receiving container 2 should accumulate, an overflow 14 feeds the excess liquid to the third receiving container 5 by means of an overflow pipe 15.

FIG. 2a is a schematic view of a cross-section A-A of a lamellar valve, in the open state, of the device according to the invention from FIG. 1. The rising pipe 8 extends inside the receiving containers 2, 3 and inside the flexible tubular or hose-like connection part 4. The rising pipe 8 is arranged centrally in the tubular or hose-like connection part 4. When the lamellar valve is open, the flexible connection part 4 is relaxed.

FIG. 2b is a schematic view of a cross-section A-A of a lamellar valve, in the closed state, of the device according to the invention from FIG. 1. The individual lamellae of the lamellar valve 6a are actuated in such a way that they press the flexible tubular or hose-like connection part 4. The flexible connection part is sealed radially. On the one hand urine flow is no longer possible, and on the other hand the squashing process merely presses the flexible connection part 4, whereas the rising pipe 8 is not squashed. The level in the rising pipe 8 may thus rise owing to the filling of the second receiving container 3, and the displacement of air in the rising pipe 8 associated therewith is not hindered.

FIG. 2c is a schematic view of a detail of the lamellar valve from FIG. 2b. In order to better illustrate the squeezing process of the flexible connection part 4, FIG. 2c shows a detailed view of the lamellar structure of the first seal 6a. Owing to the closing of the seal 6a, the flexible connection part is pressed around the rising pipe in an annular manner. As already mentioned before, no more urine liquid can flow off from the first receiving container 2 into the second receiving container 3. The function of the rising pipe 8 is not impaired.

Instead of a lamellar valve, the use of a rosette valve, an inflatable rubber ring or the like is also provided. The first and second seals can be controlled hydraulically, pneumatically or electronically.

FIG. 3a is a schematic view of a longitudinal section of the device according to the invention from FIG. 1. The device comprises a connection C1 to the measuring device 10, a connection C2 to the first seal 6a and a connection C3 to the second seal 7. The connections C1, C2 and C3 connect the measuring device 10, the first seal 6a and the second seal 7 to an electronic unit 12 from FIG. 3b. The connections C1, C2 and C3 are cable connections. Cable-free connections are also possible.

FIG. 3b shows a schematic view of a connectable unit of the device according to the invention from FIG. 3a. The unit 12 controls the first seal 6a and the second seal 7 as required. The opening and closing function of the first seal 6a and second seal 7 is triggered by means of an electronic unit 12. The unit 12 reads, processes, records and stores via the connection C1 the values of the flow rate which have been ascertained by the anemometric measuring unit 11. The liquid volume is determined by means of integral formation via the value of the flow rate. As a result of the determination of the liquid volume, the unit calculates the instantaneous fill level in the second receiving container 3. Once a defined fill level has been reached, the necessary opening and closing function of the first seal 6a and of the second seal 7 is triggered.

FIG. 3c shows a schematic view of a detail of a measuring device from FIG. 3a. As already mentioned above, a measuring device 10 is arranged in the region of the upper end of the rising pipe 8. The measuring device 10 comprises the anemometric measuring unit 11. The flow rate of the liquid is determined from the resultant airflow by means of an anemometric measuring unit 11 which is arranged in the measuring device 10. The measuring device 10 is connected to the unit 12 from FIG. 3b by means of the connection C1.

FIG. 4 shows a schematic view of a longitudinal section through an alternative device according to the invention for the continuous measurement of the flow rate of urine. In contrast to the device from FIG. 1, the device of FIG. 4 comprises a rising pipe 8 which is arranged outside the receiving containers 2 and 3 and outside the tubular or hose-like connection part 4. A lamellar valve as a first seal is not imperatively necessary for a device according to FIG. 4, but is quite possible. In this case the lamellar valve would be completely sealed when closed.

The device 1 comprises two receiving containers 2, 3 for receiving the urine liquid. A tubular or hose-like connection part 4 at the lower end of the first receiving container 2 connects the first receiving container 2 to the second receiving container 3. A first seal 6b is attached to the tubular or hose-like connection part 4 between the first receiving container 2 and the second receiving container 3. A second seal 7 is arranged at the lower end of the second receiving container 3. The device further comprises a rising pipe 8 which is connected to the second receiving container 3. A measuring device 10 is arranged in the region of the upper end of the rising pipe 8. The rising pipe 8 is arranged outside the receiving containers 2 and 3 and outside the tubular or hose-like connection part 4.

The urine secreted by a patient via a catheter device first passes via the coupling piece 16 of the device 1 into the first receiving container 2. When the seal 6b is open the urine passes through the first receiving container 2 and is forwarded into the second receiving container 3. The liquid remains in the second receiving container 3 until the second seal 7 is opened.

The rising pipe 8 is arranged in the second receiving container 3 in such a way that the lower edge of the rising pipe 8 corresponds to the lower edge of the second receiving container 3. The rising pipe 8 is fastened to the external surface of the first and second receiving containers 2, 3 by means of a fastening 17. When the urine is introduced into the second receiving container 3, the level of liquid in the second receiving container 3 rises. The level in the rising pipe 8 rises in parallel. The liquid in the rising pipe 8 displaces the air in the rising pipe 8. The more liquid arranged in the second receiving container 3, the more air is therefore displaced. An airflow results from the displaced air. The flow rate of the liquid is determined from the resultant airflow by means of an anemometric measuring unit 11 which is arranged in the measuring device 10 (see FIGS. 3a-3c).

The first receiving container 2 of the device 1 is closed by means of the seal 6b once a defined fill level has been reached in the first receiving container 2, in such a way that no more liquid can flow off from the first receiving container 2 into the second receiving container 3. The second seal 7 at the lower end of the second receiving container 3 is then opened, such that the liquid can flow off via the connection point 13 into a third receiving receptacle 5 (not shown).

If, when the first seal 6b is closed, an amount of liquid exceeding the volume of the first receiving container 2 should accumulate, an overflow 14 feeds the excess liquid to the third receiving container 5 by means of an overflow pipe 15.

FIG. 5 shows a schematic view of a longitudinal section through a further alternative device according to the invention for the continuous measurement of the flow rate of urine. The device 1 comprises a receiving container 9 for receiving liquid. A catheter 19 is connected to the device at the connection point 16. A measuring device 10 is attached to the receiving container 19. The measuring device 10 comprises an anemometric measuring unit 11 (not shown) which ascertains the speed of the airflow emerging from the device 1. As already mentioned above, the electronic unit 12 can be connected to the measuring device 10 and to the seal 18.

The urine secreted by a patient via a catheter device 19 passes via the coupling piece 16 of the device 1 into the receiving container 9. The urine introduced into the device 1 displaces the air located in the receiving container 9. The air can only escape from the device 1 at the measuring device 10 via the anemometric measuring unit 11.

The seal 18 at the lower end of the receiving container 9 is opened once a measurement has been taken, in such a way that the liquid can flow off, for example into a further receiving receptacle via the connection 13 of the device 1.

Owing to a further receiving container, which is arranged upstream of the receiving container 9 and between the receiving container 9 and the catheter 19 (not shown), it is possible to collect further liquid whilst the receiving container 9 is being emptied. When controlled, a valve which is attached to the lower end of the further receiving container stops the urine flow from the upstream receiving container to the receiving container 9 by means of an electronic unit (see the detailed description above).

1. A device for continuous measurement of flow rate of a liquid, the device comprising:
first and second receiving containers for receiving the liquid;
a tubular connection part at a lower end of the first receiving container, which connection part connects the first receiving container to the second receiving container;
a first seal between the first receiving container and the second receiving container at the tubular connection part;
a second seal at a lower end of the second receiving container;
a rising pipe which is connected to the second receiving container; and
a measuring device arranged in a region of an upper end of the rising pipe.

2. The device according to claim 1, wherein the measuring device comprises an anemometric measuring unit which ascertains airflow emerging from the rising pipe.

3. The device according to claim 1, wherein the tubular connection part is flexible.

4. The device according to claim 1, further comprising an electronic unit which can be connected to the device in order to analyse measured values from the measuring device.

5. The device according to claim 4, wherein the first and second seals are controllable.

6. The device according to claim 5, wherein the first and second seals are controllable hydraulically, pneumatically or electronically.

7. The device according to claim 5, wherein the first seal, upon activation thereof, seals the tubular connection part.

8. The device according to claim 7, wherein the first seal is a valve.

9. The device according to claim 1, wherein a receiving receptacle is connectable at a lower end of the device via a connection point.

10. The device according to claim 1, wherein the first receiving container comprises an overflow.

11. The device according to claim 1, wherein the rising pipe is arranged inside the receiving containers and inside the tubular connection part.

12. The device according to claim 1, wherein the rising pipe is arranged outside the receiving containers and outside the tubular connection part.

13. A device for continuous measurement of flow rate of a liquid, the device comprising:
at least one receiving container for receiving the liquid from a catheter that is connectable to the device at a coupling point, and
an anemometric measuring unit which ascertains speed of airflow emerging from the device.

14. A method for continuous measurement of flow rate of a liquid, the method comprising:
feeding the liquid from a first receiving container into a second receiving container and past a first seal which is open;
displacing air in a rising pipe, which is connected to the second receiving container, by the liquid;
determining the flow rate of the liquid from airflow of the displaced air in the rising pipe by means of an anemometric measuring unit;
closing the first seal in such a way that no further liquid can flow from the first receiving container into the second receiving container; and
releasing the liquid by opening a second seal at a lower end of the second receiving container.

15. The method according to claim 14, further comprising:
controlling the opening and closing function of the first and second seals by means of an electronic unit; and
processing, recording and storing, by the electronic unit, values of the flow rate which have been recorded by the anemometric measuring unit.

16. The method according to claim 15, further comprising determining volume of the liquid by means of integral formation via the flow rate.

17. The method according to claim 16, wherein as a result of the determination of the liquid volume, instantaneous fill level in the second receiving container is determined, and when a defined fill level in the second receiving container has been reached the opening and closing function of the first and second seals is triggered.

18. The device according to claim 1 wherein the tubular connection part is flexible, and wherein the first seal is openable to allow flow of the liquid from the first receiving container to the second receiving container, and closeable to move the tubular connection part and restrict flow of the liquid from the first receiving container to the second receiving container.

19. The device according to claim 18 wherein the rising pipe extends through the tubular connection part and the first seal, and the rising pipe is configured to receive the liquid from the second receiving container after the liquid passes from the first receiving container, past the first seal and into the second receiving container, such that air is displaced in the rising pipe, and wherein the measuring device determines the flow rate of the liquid based on airflow emerging from the rising pipe.

20. The device according to claim 12 wherein the rising pipe is configured to receive the liquid from the second receiving container after the liquid passes from the first receiving container, past the first seal and into the second receiving container, such that air is displaced in the rising pipe, and wherein the measuring device determines the flow rate of the liquid based on airflow emerging from the rising pipe.
